(19) United States
(12) Patent Application Publication
(10) Pub. No.: US 2023/0080952 A1
(43) Pub. Date: Mar. 16, 2023

(54) BATTERY REPLACING DEVICE AND BATTERY REPLACING SYSTEM

(71) Applicant: PANASONIC INTELLECTUAL PROPERTY MANAGEMENT CO., LTD., Osaka (JP)

(72) Inventors: Takayuki OKAWA, Tokyo (JP); Yoshinari MATSUYAMA, Osaka (JP); Masashi TAKEMURA, Kanagawa (JP); Kenichiro SHIBASAKI, Kanagawa (JP); Toshiya ZAITSU, Tokyo (JP); Kiyoshi NAKANISHI, Kanagawa (JP); Ryota SAITO, Kanagawa (JP)

(73) Assignee: PANASONIC INTELLECTUAL PROPERTY MANAGEMENT CO., LTD., Osaka (JP)

(21) Appl. No.: 17/801,750

(22) PCT Filed: Jan. 18, 2021
(86) PCT No.: PCT/JP2021/001432

§ 371 Date: Aug. 23, 2022

(30) Foreign Application Priority Data
Feb. 26, 2020 (JP) 2020-030206

(51) Int. Cl. H02J 7/00; G06Q 30/06

(52) U.S. Cl. CPC H02J 7/0042; G06Q 30/0645; H02J 7/0013

(57) ABSTRACT

A battery exchange device includes multiple battery charging modules arranged side by side on a main body wall and each configured to receive one of multiple battery packs, wherein each battery charging module includes: a tray for holding the battery pack in a predetermined setting position; a power feeding terminal for transmitting electric power for charging to the battery pack; and a lock member for prohibiting release of the battery pack from the setting position, wherein the tray is provided to be capable of advancing and retreating between a use position in which the tray protrudes from a front surface of the main body wall in a substantially horizontal direction such that the battery pack can be placed on an upper surface and a storage position in which the tray is stored in the main body wall.

### TECHNICAL FIELD

The present disclosure relates to a battery exchange device and a battery exchange system configured to charge multiple battery devices shared in a battery exchange service and to rent the charged battery devices to users.

### BACKGROUND ART

In recent years, electric vehicles such as electric motorcycles have attracted attention from the viewpoint of solving the problems of air pollution due to exhaust gas and high fuel costs. The cruising ranges of such electric vehicles are progressively extended owing to the improvement in the performance of battery devices, but such electric vehicles may cause inconvenience since they cannot travel continuously for a long time due to the necessity for charging the battery devices.

In order to eliminate such inconvenience, a battery exchange service is becoming popular, which enables the electric vehicles to travel continuously for a long time by fitting the electric vehicles with detachable battery devices so that exhausted battery devices can be exchanged with fully charged battery devices at battery stations.

In this battery exchange service, a battery exchange device may be installed in the battery station, so that the battery devices brought in by the user are stored in the battery exchange device and charged battery devices are rented to the user in exchange therefor. At this time, since the battery devices have relatively large weight, if the battery exchange is made easier to be performed by the user so that the burden on the user is reduced, the user's convenience can be enhanced.

As a technology for reducing the burden on the user who performs battery exchange, conventionally, there is known a technology which facilitates taking out of a stored battery device by making one end of the stored battery device protrude (see Patent Document 1). Also, there is known a technology in which the storage unit of the battery device can tilt forward to facilitate storing and taking-out of the battery device (see Patent Document 2).

### PRIOR ART DOCUMENT(S)

### Patent Document(s)

[Patent Document 1] JP4479977B2

[Patent Document 2] JP2014-072951A

### SUMMARY OF THE INVENTION

### Task to be Accomplished by the Invention

In the conventional technology, it is possible to avoid a shortage of the charged, rentable battery devices by arranging multiple storage units (slots) of the battery devices in vertical and horizontal directions, but it takes time and effort to find out vacant storage units to which the battery devices are to be returned. Also, in the conventional technology, the work of inserting the battery devices into the storage units when returning the battery devices is troublesome. Specifically, each battery device needs to be positioned in alignment with the opening of the storage unit and to be pushed therein. At this time, since the battery device has relatively large weight, it is necessary to grasp the handle of the battery device with one hand and to support the side surface or the bottom surface of the battery device with the other hand when positioning the battery device, and otherwise the battery device cannot be inserted into the storage unit well.

On the other hand, in the case of an electric vehicle fitted with two battery devices, for example, to replace the two battery devices, the user brings the two battery devices removed from the electric vehicle to the battery exchange device while holding the battery devices with the both hands. In this case, the user may look around for the storage units in the vacant state while holding the heavy batteries in both hands, and once the storage units in the vacant state are found, needs to insert the two battery devices held in both hands into the storage units one by one. Therefore, there is a problem that the burden on the user regarding the battery exchange is significant.

In view of the foregoing, a primary object of the present disclosure is to provide a battery exchange device and a battery exchange system which can considerably reduce the burden on the user regarding the battery exchange.

### Means to Accomplish the Task

A battery exchange device according to the present disclosure is a battery exchange device configured to charge multiple battery devices shared in a battery exchange service and to rent the charged battery devices to users, the battery exchanger device comprising multiple battery chargers arranged side by side on a support and each configured to receive one of the multiple battery devices, wherein each battery charger comprises: a tray for holding the battery device in a predetermined setting position; a power feeding terminal for transmitting electric power for charging to the battery device; and a lock member for prohibiting release of the battery device from the setting position, wherein the support is wall-shaped, and wherein the tray is provided to be capable of advancing and retreating between a use position in which the tray protrudes from a front surface of the support in a substantially horizontal direction such that the battery device can be placed on an upper surface and a storage position in which the tray is stored in the support.

Also, a battery exchange system according to the present disclosure is A ninth aspect of the invention is a battery exchange system, comprising: multiple battery devices shared in a battery exchange service; a battery exchange device configured to store and charge the battery devices and to rent the charged battery devices to users; an authentication device that executes a process related to user authentication of a person who has visited for battery exchange; and a server device that is connected to the battery exchange device and the authentication device via a network and manages user authentication at the authentication device and battery exchange at the battery exchange device, wherein the battery exchange device comprises multiple battery chargers arranged side by side on the support and each configured to receive one of the multiple battery devices, wherein each battery charger comprises: a tray for holding the battery device in a predetermined setting position; a connection terminal for transmission of electric power for charging and battery management information to and from the battery device; and a lock member for prohibiting release of the battery device from the setting position, wherein the support is wall-shaped, wherein the tray protrudes from a front surface of the support in a substantially horizontal direction such that the battery device can be placed on an upper surface, and wherein the server device acquires authentication information related to the person who has visited for battery exchange from the authentication device, determines whether to permit the battery exchange based on the authentication information, and when determining that the battery exchange may be permitted, controls a state of the tray, the connection terminal, and the lock member in the battery charger.

### Effect of the Invention

According to the present disclosure, since the trays are stored when in the vacant state, the user can immediately find the trays in the vacant state when returning the battery devices. Also, the user is only required to place the battery devices on the trays that have transitioned from the stored state to the use state. Thereby, the burden on the user regarding the battery exchange can be considerably reduced.

### BRIEF DESCRIPTION OF THE DRAWINGS

FIG. 1 is an overall configuration diagram of a battery sharing system according to the present embodiment;

FIG. 2 is a front view of a battery exchanger 3 and a face authentication machine 4;

FIG. 3 is a side view of the battery exchanger 3;

FIG. 4 is an explanatory diagram showing a battery charging module 11;

FIG. 5 is a state diagram of the battery charging module 11 when a battery pack 2 is returned;

FIG. 6 is a state diagram of the battery charging module 11 when a battery pack 2 is rented;

FIG. 7 is a block diagram showing a schematic configuration of the battery exchanger 3 and the face authentication machine 4;

FIG. 8 is a block diagram showing a schematic configuration of the battery pack 2 and the battery charging module 11;

FIG. 9 is a block diagram showing a schematic configuration of a management server 5;

FIG. 10 is a flowchart showing an operating procedure of the battery exchanger 3 and the management server 5 at the time of battery exchange;

FIG. 11 is a flowchart showing an operating procedure of the battery exchanger 3 and the management server 5 at the time of battery exchange; and

FIG. 12 is an explanatory diagram for showing the battery charging module 11 according to a modification of the embodiment.

### MODE(S) FOR CARRYING OUT THE INVENTION

A first aspect of the invention made to solve the above problem is a battery exchange device configured to charge multiple battery devices shared in a battery exchange service and to rent the charged battery devices to users, the battery exchanger device comprising multiple battery chargers arranged side by side on a support and each configured to receive one of the multiple battery devices, wherein each battery charger comprises: a tray for holding the battery device in a predetermined setting position; a power feeding terminal for transmitting electric power for charging to the battery device; and a lock member for prohibiting release of the battery device from the setting position, wherein the support is wall-shaped, and wherein the tray is provided to be capable of advancing and retreating between a use position in which the tray protrudes from a front surface of the support in a substantially horizontal direction such that the battery device can be placed on an upper surface and a storage position in which the tray is stored in the support.

According to this, since the trays are stored when in the vacant state, the user can immediately find the trays in the vacant state when returning the battery devices. Also, the user is only required to place the battery devices on the trays that have transitioned from the stored state to the use state. Thereby, the burden on the user regarding the battery exchange can be considerably reduced.

In a second aspect of the invention, the tray is provided with a display that displays a state of charge of the battery device.

According to this, the user can confirm the state of charge of each of the battery devices set in the battery chargers.

In a third aspect of the invention, the tray is provided to be pivotable between the storage position in which a tip side faces upward and the use position.

According to this, the tray can be operated smoothly. Also, it is possible to reduce the space for the battery charger.

In a fourth aspect of the invention, the lock member is provided to be capable of advancing and retreating between a lock position in which the lock member restrains the battery device and an unlock position in which the lock member does not restrain the battery device.

According to this, since the lock member advances and retreats between the lock position and the unlock position, the user can easily place the battery device on the tray and take the battery device from the tray. In this case, for example, it is preferable if the lock member is provided on the support to be moveable forward and backward and protrudes from the support to restrain the battery device when the battery device is in the setting position.

In a fifth aspect of the invention, the power feeding terminal is provided to be capable of advancing and retreating between a connection position in which the power feeding terminal is connected to the battery device and a non-connection position in which the power feeding terminal is not connected to the battery device.

According to this, since the power feeding terminal advances and retreats between the connection position and the non-connection position, the user can easily place the battery device on the tray and take the battery device from the tray.

In a sixth aspect of the invention, the power feeding terminal is provided on the tray to be movable up and down, and when the battery device is in the setting position, the power feeding terminal protrudes from the tray and is connected to the battery device.

According to this, the power feeding terminal can be operated smoothly. Also, when the tray is in the stored state, the power feeding terminal is not exposed and the power feeding terminal can be protected.

In a seventh aspect of the invention, the battery device is placed on the tray in a vertical placement state in which a handle is positioned on an upper side.

According to this, the user may place the battery device held in hand onto the tray without any additional action, and thus, the burden on the user can be reduced.

In an eighth aspect of the invention, the support has a recess for receiving a part of the battery device, and a guide surface for guiding the battery device to the setting position is formed on a peripheral part of the recess.

According to this, when the user presses the battery device against the support, the battery device is naturally positioned in the setting position, and thus, the burden on the user can be reduced.

A ninth aspect of the invention is a battery exchange system, comprising:

multiple battery devices shared in a battery exchange service; a battery exchange device configured to store and charge the battery devices and to rent the charged battery devices to users; an authentication device that executes a process related to user authentication of a person who has visited for battery exchange; and a server device that is connected to the battery exchange device and the authentication device via a network and manages user authentication at the authentication device and battery exchange at the battery exchange device, wherein the battery exchange device comprises multiple battery chargers arranged side by side on the support and each configured to receive one of the multiple battery devices, wherein each battery charger comprises: a tray for holding the battery device in a predetermined setting position; a connection terminal for transmission of electric power for charging and battery management information to and from the battery device; and a lock member for prohibiting release of the battery device from the setting position, wherein the support is wall-shaped, wherein the tray protrudes from a front surface of the support in a substantially horizontal direction such that the battery device can be placed on an upper surface, and wherein the server device acquires authentication information related to the person who has visited for battery exchange from the authentication device, determines whether to permit the battery exchange based on the authentication information, and when determining that the battery exchange may be permitted, controls a state of the tray, the connection terminal, and the lock member in the battery charger.

According to this, as in the first aspect of the invention, the burden on the user regarding the battery exchange can be considerably reduced. Also, the battery exchange can be permitted to only legitimate users who are preregistered.

In a tenth aspect of the invention, the server device controls the state of the tray of each battery charger of the multiple battery chargers that is in a vacant state in which the battery device is not set.

According to this, by controlling the state of the trays, it becomes a state in which the battery devices can be placed on the trays so that the user can return the battery devices.

In an eleventh aspect of the invention, the server device controls the state of the connection terminal and the lock member of each battery chargers of the multiple battery chargers that is in a state in which a charged, rentable battery device is set.

According to this, by controlling the state of the power feeding terminal and the lock member, it becomes a state in which the battery devices can be removed so that the battery devices can be rented to the user.

In the following, embodiments of the present disclosure will be described with reference to the appended drawings.

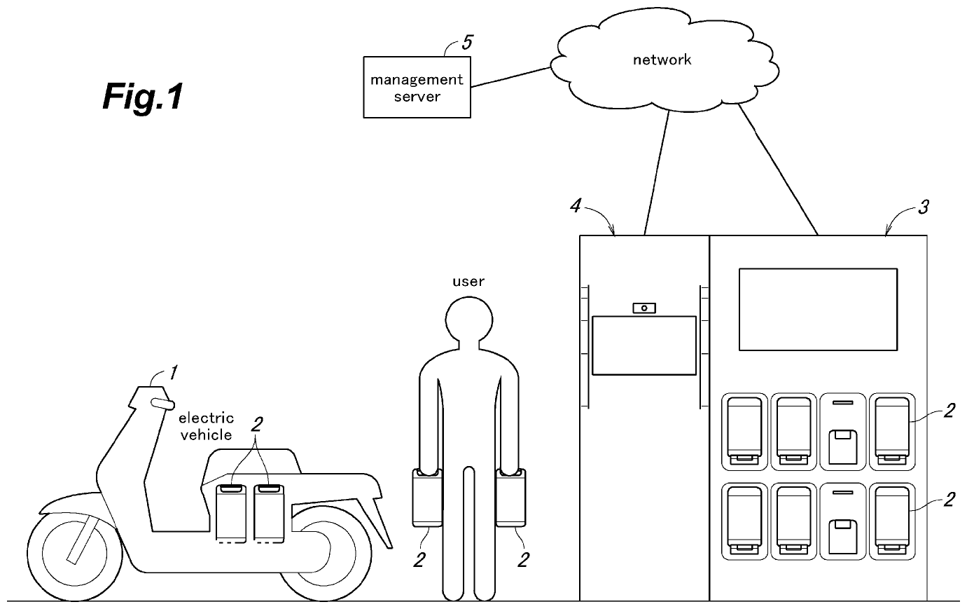

FIG. 1 is an overall configuration diagram of a battery sharing system according to an embodiment.

This battery sharing system is configured to provide a service (battery exchange service) in which battery packs 2 (battery devices) fitted to electric vehicles 1 such as electric motorcycles can be shared among a plurality of users, and includes a battery exchanger 3 (battery exchange device), a face authentication machine 4 (authentication device), and a management server 5 (server device).

The battery exchanger 3, the face authentication machine 4, and the management server 5 are connected via the Internet. Note that the battery exchanger 3 and the face authentication machine 4 may be connected to the network via a wireless communication such as a mobile communication network and a wireless LAN.

Each electric vehicle 1 is fitted with the battery packs 2, and travels on the electric power of the battery packs 2. The electric vehicle 1 consists of an electric motorcycle in the example shown in FIG. 1, but may consist of a four-wheeled vehicle. Further, the electric vehicle 1 may be a mobility device not designed for public roads such as an electric wheelchair, an electric cart, or a riding cart for use in a theme park, a golf course, or the like.

The battery exchanger 3 stores and charges the battery packs 2 returned by the users, and rents the charged battery packs 2 to the users in exchange for the returned battery packs 2. The battery exchanger 3 is installed in a battery station attached to a facility (store) such as a convenience store and a gas station.

The face authentication machine 4 performs a process related to face authentication as user authentication for identifying a person who has visited for battery exchange. This face authentication machine 4 is installed on the front side of the battery exchanger 3, and the user first comes in front of the face authentication machine 4, and after having undergone face authentication by the face authentication machine 4, moves to the front of the battery exchanger 3 to perform the battery exchange work. The face authentication machine 4 is disposed to be adjacent to the battery exchanger 3 in the battery station.

The management server 5 registers and manages persons who subscribe to the battery exchange service and use the battery packs 2 as users (members) (user management). Also, the management server 5 registers and manages the battery packs 2 shared in the battery exchange service (battery management).

The battery packs 2 to be fitted to electric vehicles 1 are given as an example in the present embodiment, but battery devices to which the battery packs 2 are fitted are not limited to the electric vehicles 1, and may be portable power supply devices, for example.

Also, in the present embodiment, the management server 5 has two functions of face authentication and battery management, but the functions of the management server 5 may be separately performed by a face authentication server that performs the process related to face authentication and a battery management server the performs the process related to battery management. Further, the functions of the face authentication server may be separately performed by a face management server that centrally manages the user information (face image, specific information, etc.) and a face matching server that performs a face matching process.

In the present embodiment, face authentication is performed as user authentication for identifying the user who has visited for battery exchange, but user authentication other than face authentication may be performed. For example, authentication may be performed based on communication with an RFID (radio frequency identifier) tag, a noncontact type IC card, or a user terminal having a function of NFC (near field communication), which is carried by the user. Also, authentication may be performed based on a two-dimensional code containing authentication information displayed on a smartphone as the user terminal.

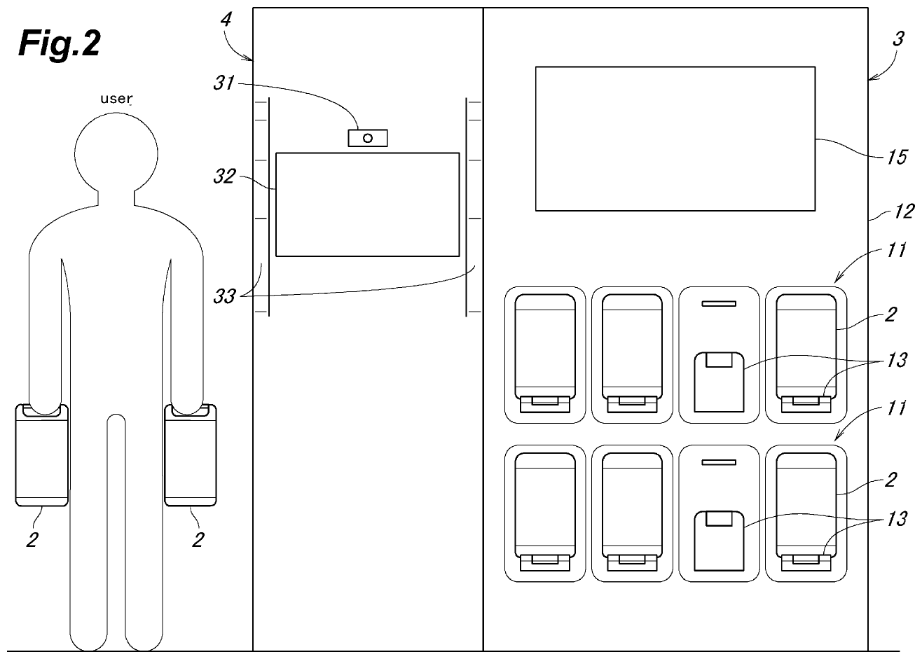

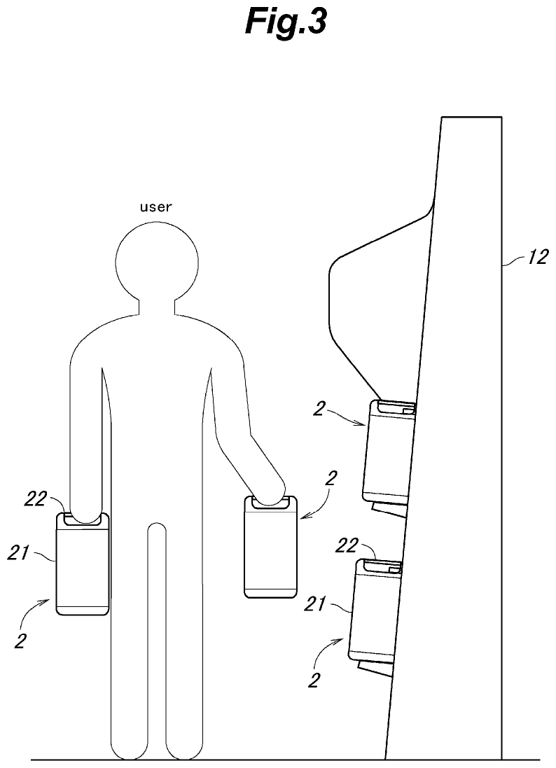

Next, description will be made of the battery exchanger 3 and the face authentication machine 4. FIG. 2 is a front view of the battery exchanger 3 and the face authentication machine 4. FIG. 3 is a side view of the battery exchanger 3.

As shown in FIG. 2, the battery exchanger 3 include multiple battery charging modules 11 (battery chargers) each being configured to receive a single battery pack 2. The battery charging modules 11 are provided in a state supported by a main body wall 12 (support). The battery charging module 11 are arranged to form multiple rows arranged vertically. In the example shown in FIG. 2, the battery charging modules 11 form two rows arranged vertically.

As shown in FIG. 3, each battery pack 2 is provided with a handle 22 on an upper portion of a main body 21, so that the user can carry the battery pack 2 by grasping the handle 22. Also, the battery pack 2 is installed in the electric vehicle 1 in an upright state with the handle 22 facing upward (see FIG. 1), so that the user can remove the battery pack 2 by grasping and pulling up the handle 22.

The battery charging module 11 is provided with a tray 13 on which a single battery pack 2 is set. This tray 13 supports the bottom surface of the main body 21 of the battery pack 2. The battery pack 2 is set on the tray 13 in a vertical placement state with the handle 22 side up and in an inclined state with the handle 22 side inclined obliquely rearward. Note that the rear side surface of the main body 21 of the battery pack 2 is supported by the main body wall 12.

When exchanging the battery packs 2, first, for return of the battery packs 2, the user looks for the battery charging modules 11 in the vacant state and sets the battery packs 2 on the trays 13 of the battery charging modules 11 in the vacant state. Next, for rental of the charged battery packs 2, the user looks for the charged battery packs 2 and takes out the charged battery packs 2 from the trays 13 of the battery charging modules 11.

Also, as shown in FIG. 2, the battery exchanger 3 is provided with a display 15. This display 15 usually operates as a digital signage for displaying contents such as advertisement and, when the face authentication of the person who has visited for battery exchange is successful, displays a guide screen related to battery exchange. Specifically, it is preferred if the setting positions of the battery packs 2 to be returned and the removal positions of the charged battery packs 2 are guided by illustration so that the user will not be confused about the battery exchange operation.

The face authentication machine 4 is provided with a camera 31 and a display 32. The camera 31 captures an image of a person who has visited for battery exchange (visitor). The display 32 displays a screen related to face authentication, etc. The display 32 may be constituted of a touch panel display, and in this case, the user can perform screen operation. Also, privacy panels 33 are provided on left and right sides of the display 32.

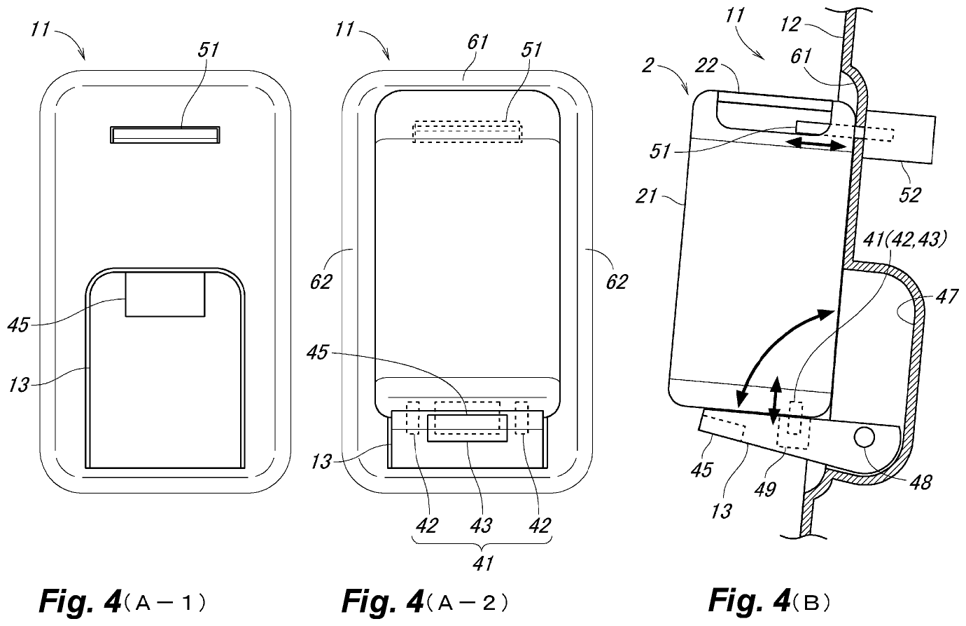

Next, description will be made of the battery charging module 11. FIG. 4 is an explanatory diagram showing the battery charging module 11. Here, FIG. 4(A-1) is a front view of the battery charging module 11 in the vacant state in which the battery pack 2 is not set therein. FIG. 4(A-2) is a front view of the battery charging module 11 with the battery pack 2 set therein. FIG. 4(B) is a sectional view showing the battery charging module 11 with the battery pack 2 set therein as viewed from side.

As shown in FIG. 4(A-2), the tray 13 is provided with connection terminals 41. The connection terminals 41 include power feeding terminals 42 and a communication terminal 43. The power feeding terminals 42 transmit electric power for charging supplied at the time of charging to the battery pack 2. The communication terminal 43 transmits and receives information to and from the battery pack 2. Note that configuration may be made such that the power feeding terminals 42 are also used as the communication terminal 43.

As shown in FIGS. 4(A-1) and 4(A-2), a display 45 for displaying the state of charge of the battery pack 2 is provided on the tip side of the tray 13. This display 45 displays the state of charge of the battery pack 2 with different colors by switching between light sources (LED lamps or the like) of multiple colors, for example. For example, a charging completion state (rentable state) is displayed with green color, and a charging incompletion state (unrentable state) is displayed with red color. Note that the display 45 is provided to straddle two surfaces of the tray 13 on the tip side.

Therefore, in both of the stored state shown in FIG. 4(A-1) and the use state shown in FIG. 4(A-2), the user can visually recognize the display 45.

As shown in FIG. 4(B), the tray 13 is provided to be capable of advancing and retreating between a storage position in which the tray 13 is stored in a tray storing part 47 of the main body wall 12 and a use position in which the tray 13 protrudes from the front surface of the main body wall 12 in the substantially horizontal direction. In the present embodiment, the tray 13 is provided to be pivotable about a support shaft 48 between the storage position in which the tip side faces upward and the use position in which the tip side protrudes forward.

The connection terminals 41 (the power feeding terminals 42 and the communication terminal 43) are provided to be capable of advancing and retreating between a connection position in which the connection terminals 41 are connected to the battery pack 2 and a non-connection position in which the connection terminals 41 are not connected to the battery pack 2. In the present embodiment, the connection terminals 41 are provided on the tray 13 to be movable up and down, and when the battery pack 2 is in the setting position, protrude from the tray 13 and are connected to the battery pack 2. The connection terminals 41 are driven to advance/retreat by a terminal driver 49.

Also, the battery charging module 11 is provided with a lock member 51 for prohibiting release of the battery pack 2 from the setting position. The lock member 51 has a flat plate shape and restrains the battery pack 2 by restricting the upper surface of the main body 21 of the battery pack 2.

The lock member 51 is provided to be capable of advancing and retreating between a lock position in which the lock member 51 restrains the battery pack 2 and an unlock position in which the lock member 51 does not restrain the battery pack 2. In the present embodiment, the lock member 51 is provided on the main body wall 12 to be movable forward and backward, and when the battery pack 2 is in the setting position, protrudes from the main body wall 12 and restrains the battery pack 2. The lock member 51 is driven to advance/retreat by a lock driver 52.

Note that the lock member 51 in the lock state prohibits upward movement of the battery pack 2. On the other hand, the connection terminals 41 in the connection state prohibit forward movement of the battery pack 2. Thereby, the lock member 51 and the connection terminals 41 cooperate to constitute a lock mechanism that restrains the battery pack 2, whereby release of the battery pack 2 from the tray 13 is prohibited.

Also, the main body wall 12 is provided with recesses 61 for the respective battery charging modules 11 to each receive a part of the battery pack 2. A peripheral part, particularly left and right edge parts, of the recess 61 is formed with a guide surface 62 for guiding the battery pack 2 to the predetermined setting position. Due to the guide surface 62, when the user presses the battery pack 2 against the main body wall 12, the battery pack 2 is naturally positioned in the setting position. It is also possible to configure the main body wall 12 to have a flat surface and to form a recess (not shown in the drawings) on the upper surface of each tray 13 so that the battery pack 2 can be positioned in the setting position only by being placed on the tray 13.

Note that in the setting position of the battery pack 2, the power feeding terminals 42 and the communication terminal 43 of the tray 13 align with the power feeding terminals and the communication terminal of the battery pack 2. The guide surface 62 may be formed to have a cross section curved in an arc shape or may consist of a tapered inclined surface.

In the present embodiment, the lock member 51 having a flat plate shape is provided but the lock member 51 may have another shape such as a hook shape. Also, in the present embodiment, the lock member 51 prohibits movement of the battery pack 2 by contacting the upper surface of the main body 21 of the battery pack 2, but the lock member 51 may be configured to engage with the handle 22 of the battery pack 2.

Further, in the present embodiment, the tray 13 is configured to pivot in the vertical direction but the tray 13 may be configured to slide in the fore and aft direction.

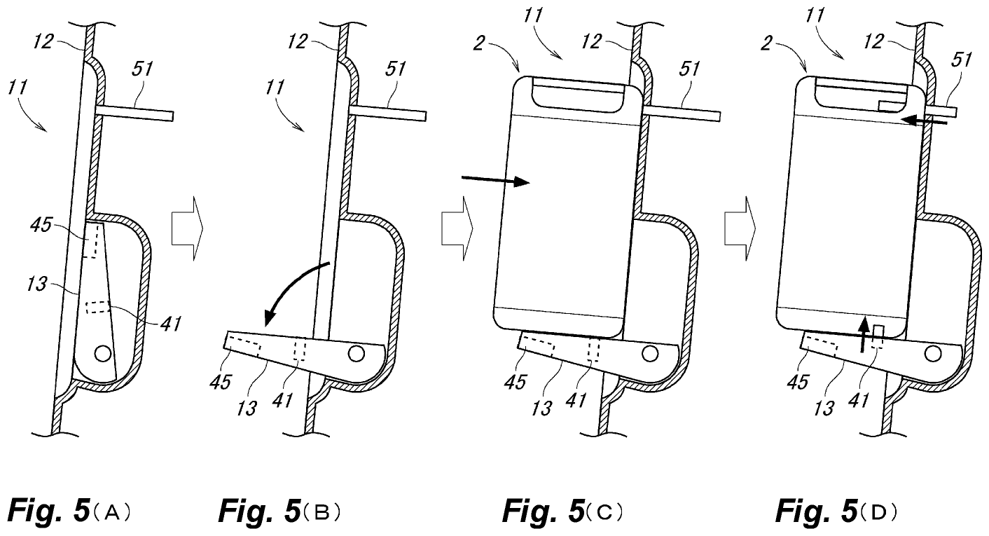

Next, description will be made of the operation of the battery charging module 11 when the battery pack 2 is returned. FIG. 5 is a state diagram of the battery charging module 11 when the battery pack 2 is returned.

In the battery charging module 11 in the vacant state, when the face authentication is completed and the return permission notification is received from the management server 5, the tray 13 in the stored state as shown in FIG. 5(A) opens, namely, the tray 13 pivots forward to transition to a state in which the battery pack 2 can be placed thereon, as shown in FIG. 5(B).

Next, when the user has placed the battery pack 2 on the tray 13 as shown in FIG. 5(C), the connection terminals 41 (the power feeding terminals and the communication terminal) protrude from the tray 13 to transition to the connection state, as shown in FIG. 5(D). Simultaneously, the lock member 51 protrudes from the main body wall 12 to transition to the lock state.

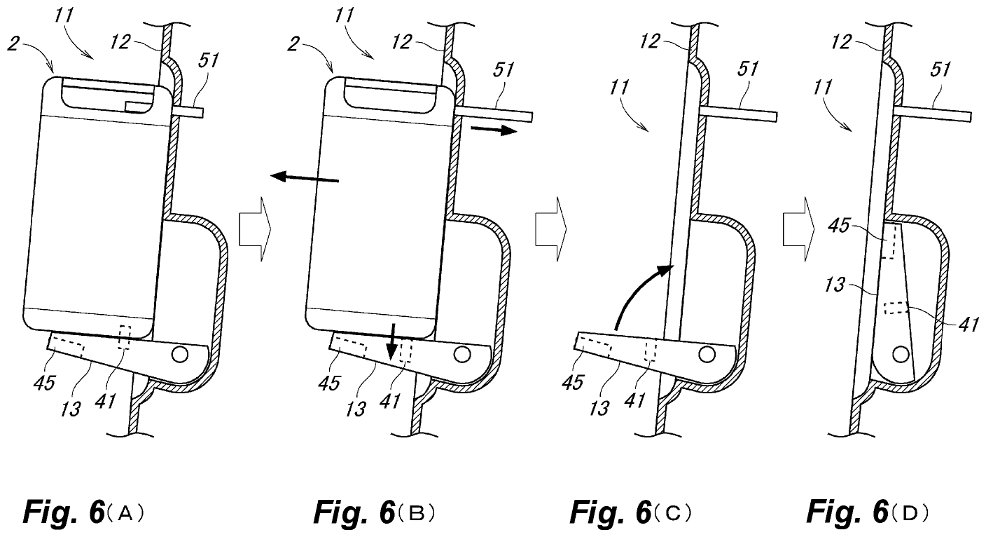

Next, description will be made of the operation of the battery charging module 11 when the battery pack 2 is rented. FIG. 6 is a state diagram of the battery charging module 11 when the battery pack 2 is rented.

In the battery charging module 11 in the charging completion state, when the rental permission notification is received from the management server 5, the display 45 blinks to guide the battery packs 2 to be rented to the user. Also, the lock member 51 moves backward from the lock state shown in FIG. 6(A) to transition to the unlock state shown in FIG. 6(B). Simultaneously, the connection terminals 41 are lowered to transition to the non-connection state.

Subsequently, when the user has removed the battery pack 2 from the tray 13 as shown in FIG. 6(C), the tray 13 is closed, namely, the tray 13 pivots upward to transition to the stored state shown in FIG. 6(D).

Note that in the present embodiment, the connection terminals 41 perform the connecting operation in conjunction with and at the same timing as the locking operation of the lock member 51, but the locking operation of the lock member 51 and the connecting operation of the connection terminals 41 may be performed at different timings. Also, in the present embodiment, the connection terminals 41 perform the disconnecting operation in conjunction with and at the same timing as the unlocking operation of the lock member 51, but the unlocking operation of the lock member 51 and the disconnecting operation of the connection terminals 41 may be performed at different timings. For example, configuration may be made such that when the battery pack 2 is returned, first, the connection terminals 41 perform the connecting operation, and when the returned battery pack 2 is determined to be a battery pack covered by the battery exchange service, the lock member 51 performs the locking operation.

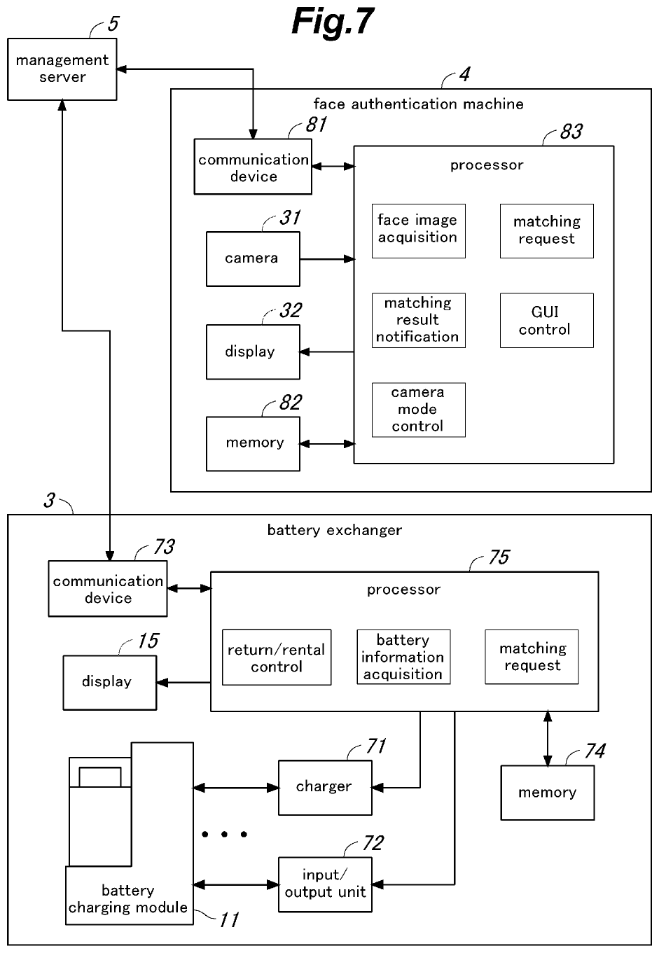

Next, description will be made of a schematic configuration of the battery exchanger 3 and the face authentication machine 4. FIG. 7 is a block diagram showing a schematic configuration of the battery exchanger 3 and the face authentication machine 4.

The battery exchanger 3 includes a charger 71, an input/output unit 72, a communication device 73, a memory 74, and a processor 75 in addition to the battery charging modules 11 and the display 15.

The charger 71 charges the battery packs 2 via the battery charging modules

The input/output unit 72 transmits and receives information to and from the battery packs 2 via the battery charging modules 11. For example, the model numbers, alerts, deterioration information on the battery packs 2 are received from the battery packs 2 via the battery charging modules 11. Also, control signals for operating various parts of the battery charging modules 11 are outputted to the battery charging modules 11.

The display 15 displays a guide screen related to exchange of the battery packs 2. Also, the display 15 functions as a digital signage and displays various advertisement at usual times or when the battery exchange is not performed.

The communication device 73 communicates with the management server 5 via the network.

The memory 74 stores programs to be executed by the processor 75 and the like.

The processor 75 executes the programs stored in the memory 74 thereby to perform various processes related to the battery exchange. In the present embodiment, the processor 75 performs a return/rental control process, a battery information acquisition process, a matching request process, etc.

In the return/rental control process, the processor 75 controls the battery charging modules 11 so as to perform a predetermined operation for the return and rental of the battery packs 2. In the present embodiment, the communication device 73 receives instruction information related to whether rental of the battery packs 2 may be permitted from the management server 5, and the processor 75 performs necessary control according to the instruction information from the management server 5.

In the battery information acquisition process, the processor 75 acquires battery management information (model number (model identification information) of the battery pack 2, etc.) from each returned battery pack 2 via the input/output unit 72. The battery management information is transmitted from the communication device 73 to the management server 5.

In the matching request process, the processor 75 transmits a request for battery matching from the communication device 73 to the management server 5. The request for battery matching includes the model number of each battery pack 2.

The face authentication machine 4 includes a communication device 81, a memory 82, and a processor 83 in addition to the camera 31 and the display 32.

The camera 31 captures an image of a person (visitor) who has visited for battery exchange.

The display 32 displays a guide screen related to face authentication and the like.

The communication device 81 communicates with the management server 5 via the network.

The memory 82 stores programs to be executed by the processor 83 and the like.

The processor 83 executes the programs stored in the memory 82 thereby to perform various processes related to the face authentication. In the present embodiment, the processor 83 performs a face image acquisition process, a matching request process, a matching result notification process, a GUI control process, a camera mode control process, etc.

In the face image acquisition process, the processor 83 detects a face of a person from the image captured by the camera 31 (face detection) and cuts out a face region from the captured image (face cut-out) thereby to acquire the face image (face image for authentication) of the target person.

In the matching request process, the processor 83 transmits a request for face matching to the management server 5 from the communication device 81. This request for face matching includes the face image of the visitor.

In the matching result notification process, the processor 83 causes the matching result acquired from the management server 5 via the communication device 73 to be displayed on the display 32 thereby to notify the matching result, namely, whether the battery exchange may be permitted, to the user.

In the GUI control process, the processor 83 causes a screen related to the face authentication delivered from the management server 5 to be displayed on the display 32. Also, in response to the user' input operation using an input function of the display 32 (here, a touch panel), the processor 83 acquires input information and performs screen control.

In the camera mode control process, the processor 83 switches an operation mode related to the processing of the images captured by the camera 31 between a face authentication mode and a security monitoring mode. Specifically, the processor 83 usually operates in the face authentication mode, and upon failure of face authentication, transitions from the face authentication mode to the security monitoring mode. In the security monitoring mode, the processor 83 uploads the images captured by the camera 31 to the management server 5 as monitoring images. In the management server 5, the monitoring images uploaded from the battery exchanger 3 are accumulated. Thereby, it is possible to check the behavior of a suspicious person at a later time.

Note that the battery exchanger 3 and the face authentication machine 4 may be provided with an interface that enables direct exchange of required information between the battery exchanger 3 and the face authentication machine 4.

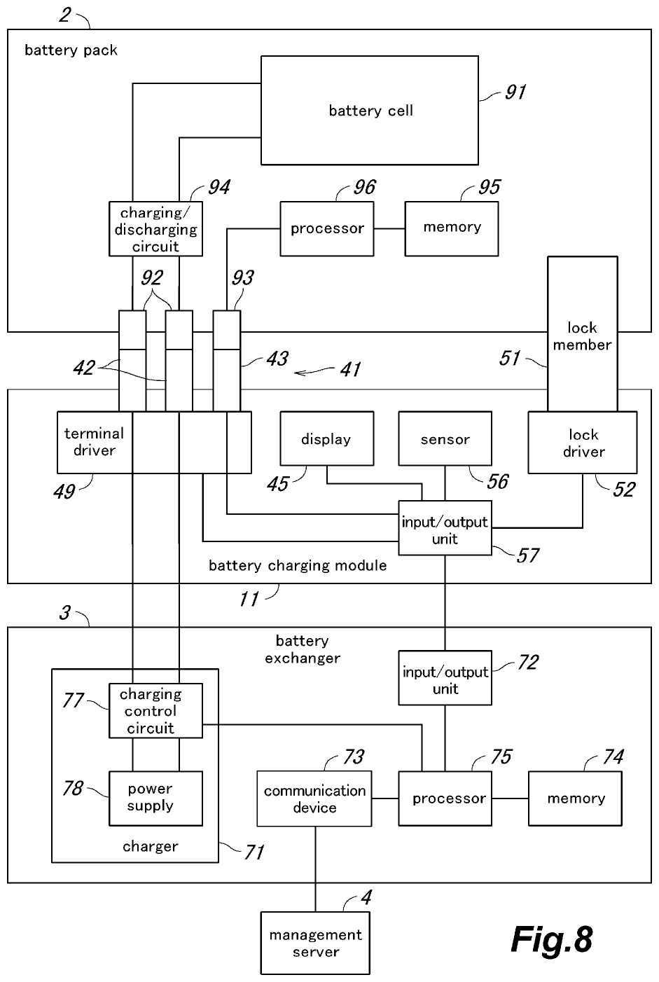

Next, description will be made of a schematic configuration of the battery pack 2 and the battery charging module 11. FIG. 8 is a block diagram showing a schematic configuration of the battery pack 2 and the battery charging module 11.

The battery pack 2 includes a battery cell 91, power feeding terminals 92, a communication terminal 93, a charging/discharging circuit 94, a memory 95, and a processor 96.

The power feeding terminals 92 transmit electric power for charging supplied from the battery charging module 11 at the time of charging. Also, the power feeding terminals 92 transmit the electric power of the battery cell 91 to the electric vehicle 1 when installed in the electric vehicle 1.

The communication terminal 93 transmits and receives information to and from the battery charging module 11 and the battery pack 2. Note that configuration may be made such that the power feeding terminals 92 are also used as the communication terminal.

The charging/discharging circuit 94 performs an operation of charging the battery cell 91 with the electric power for charging supplied from the battery charging module 11 and an operation of discharging the battery cell 91 to supply the electric power for traveling to the electric vehicle 1.

The memory 95 stores programs to be executed by the processor 96. Also, the memory 95 stores the battery management information necessary for management of the battery exchange service. The battery management information includes, for example, the ID (individual identification information such as a serial number) of the battery pack 2, the ID of the user using the battery pack 2, an alert representing an abnormality state of the battery pack 2, history information such as the number of times of the past charging, deterioration information of the battery cell 91, etc.

The processor 96 controls various parts of the battery pack 2. For example, various environment sensors (temperature, humidity, voltage, electric current) are provided, and the processor 96 detects an abnormality and a deterioration state of the battery cell 91 and stores an alert and deterioration information in the memory 95.

The battery charging module 11 includes a sensor 56 and an input/output unit 57 in addition to the display 45, the lock member 51, the connection terminals 41 (the power feeding terminals 42 and the communication terminal 43), the terminal driver 49, and the lock driver 52.

The sensor 56 detects the battery pack 2 set in the battery charging module 11. With this sensor 56, placement of the battery pack 2 on the tray 13 by the user as well as removal of the battery pack 2 from the tray 13 by the user are detected. Note that configuration may be made such that the sensor 56 detects displacement of the battery pack 2 from the setting position and the display 15 displays a guide prompting positioning of the battery pack 2.

The input/output unit 57 is connected to the input/output unit 72 of the battery exchanger 3 as well as to the battery pack 2 via the communication terminal 43, and relays transmission and reception of information between the battery exchanger 3 and the battery pack 2. Also, the input/output unit 57 outputs the display signal inputted from the input/output unit 72 of the battery exchanger 3 to the display 45. In addition, the input/output unit 57 outputs the driving signal inputted from the input/output unit 72 of the battery exchanger 3 to the terminal driver 49 and the lock driver 52.

The charger 71 of the battery exchanger 3 is provided with a charging control circuit 77 and a power supply 78. The charging control circuit 77 controls the electric power for charging supplied from the power supply 78 to the battery charging module 11.

The processor 75 of the battery exchanger 3 performs control related to charging of the battery pack 2 in the battery charging module 11. Specifically, the processor 75 controls the charging control circuit 77 based on the information acquired from the battery pack 2 via the input/output unit 72. Also, the processor 75 controls the display 45 based on the charging information acquired from the battery pack 2 and makes the display 45 display a color corresponding to the state of charge of the battery pack 2. Further, the processor 75 controls the lock driver 52 of the battery charging module 11 for causing the lock member 51 to advance and retreat and the terminal driver 49 of the battery charging module 11 for causing the connection terminals 41 (the power feeding terminals 42 and the communication terminal 43) to advance and retreat.

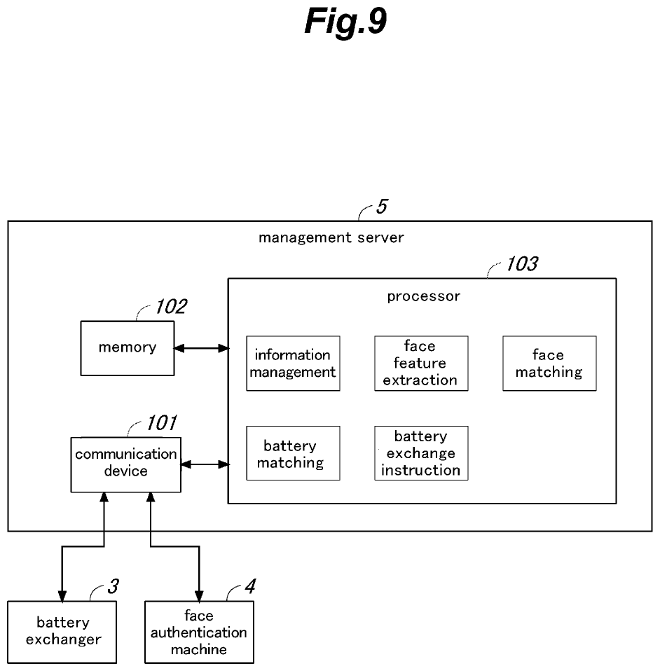

Next, description will be made of a schematic configuration of the management server 5. FIG. 9 is a block diagram showing a schematic configuration of the management server 5.

The management server 5 includes a communication device 101, a memory 102, and a processor 103.

The communication device 101 communicates with the battery exchanger 3 and the face authentication machine 4 via the network.

The memory 102 stores registration information (user management information) of a user management table, programs to be executed by the processor 103, and the like.

The processor 103 executes the programs stored in the memory 102 thereby to perform various processes related to the face authentication and the battery exchange. In the present embodiment, the processor 103 performs an information management process, a face feature extraction process, a face matching process, a battery matching process, a battery exchange instruction process, etc.

In the information management process, at the time of user registration, the processor 103 acquires the face feature information of the target person from a registration machine (not shown in the drawings) and registers it in the user management table.

In the face feature extraction process, at the time of battery exchange, the processor 103 extracts face feature information from the face image of the visitor acquired from the face authentication machine 4. Note that at the time of user registration, the face feature information is extracted from the face image of the target person of the user registration acquired from the registration machine (not shown in the drawings).

In the face matching process, at the time of battery exchange, the processor 103 performs face matching to determine whether the visitor is a legitimate user by comparing the face feature information of the visitor acquired in the face feature extraction process with the pieces of face feature information registered in the user management table. Note that a face image of a user is acquired every time the battery exchange is performed, and therefore, the face feature information extracted from this face image may be used to update the pieces of face feature information of the users registered in the user management table.

In the battery matching process, the processor 103 performs battery matching to determine whether the battery packs 2 returned by the user to the battery exchanger 3 are batteries covered by the battery exchange service.

In the battery exchange instruction process, the processor 103 determines whether the battery exchange may be permitted and notifies the determination result, namely, whether the battery exchange may be permitted, to the battery exchanger 3.

Specifically, if it is determined in the face matching process that the visitor is a legitimate user and it is determined in the battery matching process that the battery packs 2 returned by the user are batteries covered by the battery exchange service, an exchange permission notification that permits the battery exchange is transmitted from the communication device 101 to the battery exchanger 3. Also, in a case where it is determined that the visitor is not a legitimate user or the battery packs 2 returned by the user are different from the battery packs 2 being rented to the user, an exchange non-permission notification that does not permit the battery exchange is transmitted from the communication device 101 to the battery exchanger 3.

Note that in the present embodiment, the face feature extraction process is performed by the management server 5 but configuration may be made such that the face authentication machine 4 performs the face feature extraction process and forwards the face feature information extracted from the face image of the visitor to the management server 5.

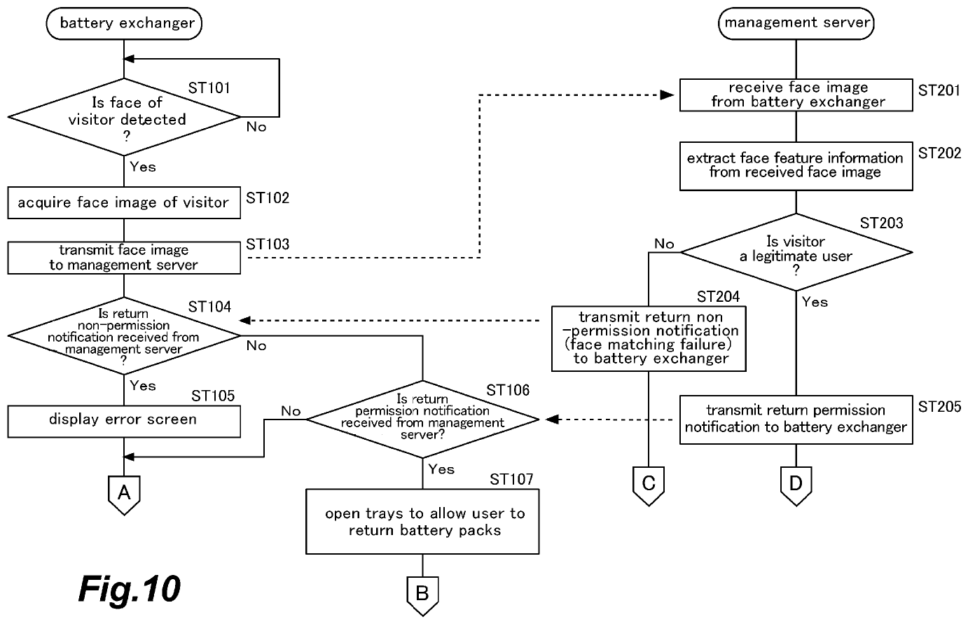

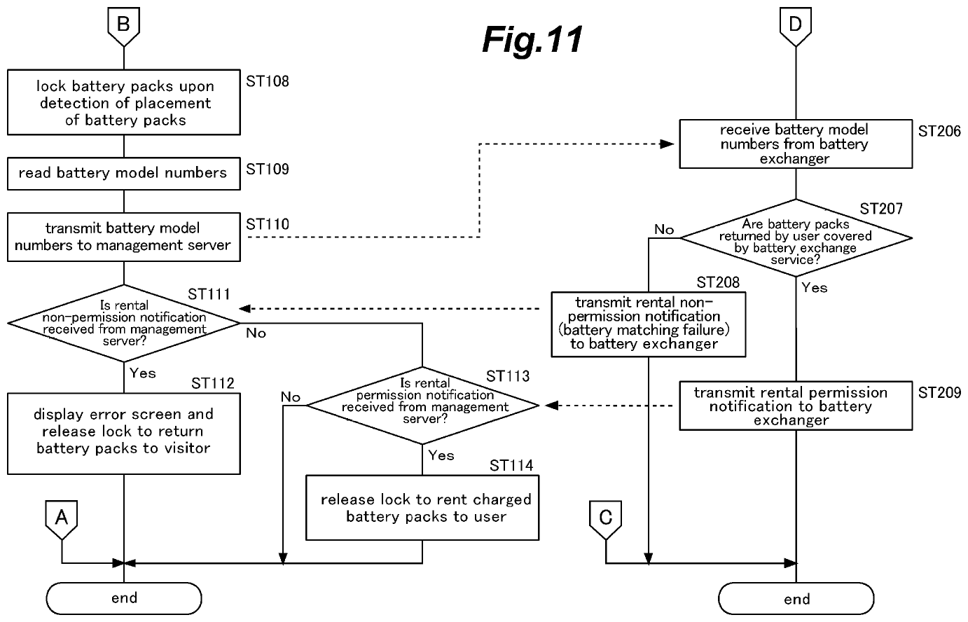

Next, an operating procedure of the battery exchanger 3 and the management server 5 at the time of battery exchange will be described. FIGS. 10 and 11 are flowcharts showing an operating procedure of the battery exchanger 3 and the management server 5 at the time of battery exchange.

As shown in FIG. 10, in the battery exchanger 3, first, when the processor 75 detects a face of a visitor (a person who has visited for battery exchange) from the image captured by the camera 31 (Yes in ST101), the processor 75 acquires the face image of the visitor from the image captured by the camera 31 (ST102). Then, the processor 75 transmits the face image of the visitor from the communication device 73 to the management server 5 (ST103).

In the management server 5, when the face image of the visitor transmitted from the battery exchanger 3 is received by the communication device 101 (ST201), the processor 103 extracts the face feature information of the visitor from the received face image (ST202).

Next, the processor 103 compares the face feature information of the visitor with the pieces of face feature information registered in the user management table to determine whether the visitor is a legitimate user (ST203).

Here, when the visitor is not a legitimate user (No in ST203), a return non-permission notification is transmitted from the communication device 101 to the battery exchanger 3 (ST204).

On the other hand, when the visitor is a legitimate user (Yes in ST203), a return permission notification is transmitted from the communication device 101 to the battery exchanger 3 (ST205).

In the battery exchanger 3, when the return non-permission notification is received from the management server 5 (Yes in ST104), the processor 75 causes the display 15 to display an error screen for notifying the user that the battery exchange cannot be permitted (ST105).

Also, when the return permission notification is received from the management server 5 (Yes in ST106), the processor 75 performs control to open the trays 13 (ST107). Thereby, the visitor can return the battery packs 2 to the battery exchanger 3.

Then, as shown in FIG. 11, in the battery exchanger 3, the processor 75 performs control to lock the battery pack 2 in response to detection of placement of the battery packs 2 on the trays 13, namely, return of the battery packs 2 (ST108). Subsequently, the model numbers of the battery packs 2 are read (ST109), and the model numbers of the battery packs 2 are transmitted from the communication device 73 to the management server 5 (ST110).

In the management server 5, when the model numbers of the battery packs 2 transmitted from the battery exchanger 3 are received by the communication device 101 (ST206), the processor 103 determines whether the battery packs 2 returned by the user to the battery exchanger 3 are batteries covered by the battery exchange service based on the received model numbers (ST207).

Here, when the battery packs 2 returned by the user are not batteries covered by the battery exchange service (No in ST207), the rental non-permission notification is transmitted from the communication device 101 to the battery exchanger 3 (ST208).

On the other hand, when the battery packs 2 returned by the user are batteries covered by the battery exchange service (Yes in ST207), the rental permission notification is transmitted from the communication device 101 to the battery exchanger 3 (ST209).

In the battery exchanger 3, when the rental non-permission notification is received from the management server 5 (Yes in ST111), the processor 75 causes the display 15 to display an error screen for notifying the user that the battery exchange cannot be permitted and, to return the battery packs 2 brought in by the visitor to the visitor, performs control to unlock the battery packs 2 (ST112).

Also, when the rental permission notification is received from the management server 5 (Yes in ST113), to rent the charged battery packs 2 to the user, the processor 75 performs control to unlock the battery packs 2 (ST114). Thereby, the visitor can take out the charged battery packs 2 from the battery exchanger 3.

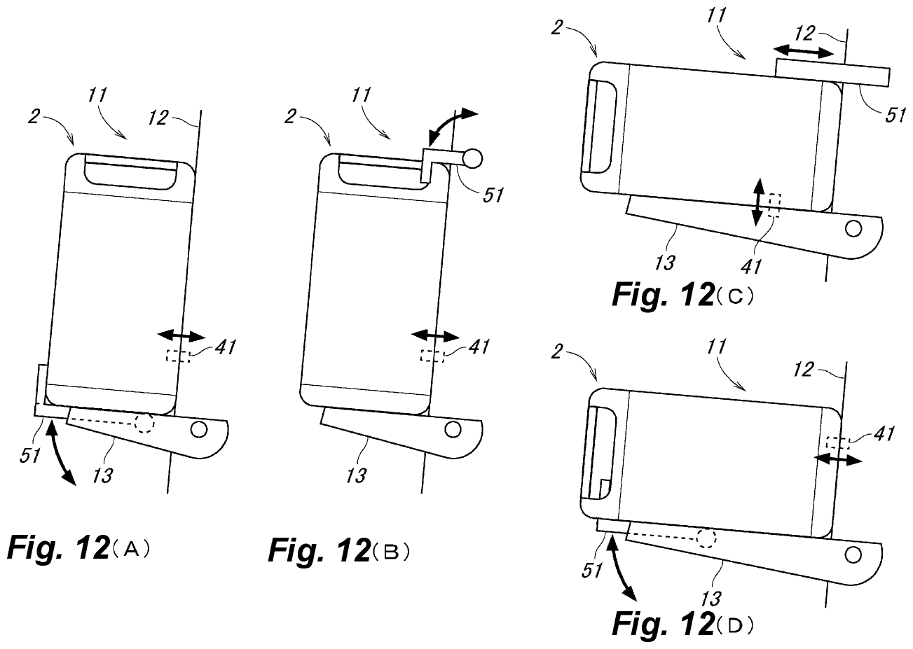

Next, a modification of the present embodiment will be described. FIG. 12 is an explanatory diagram for showing the battery charging module 11 according to a modification of the present embodiment.

In the present embodiment (see FIG. 4), the connection terminals 41 (the power feeding terminals and the communication terminal) were provided on the tray 13, but the connection terminals 41 may be provided on the main body wall 12. Also, the lock member 51 was provided on the main body wall 12, but the lock member 51 may be provided on the tray 13.

In the example shown in FIG. 12(A), the connection terminals 41 are provided on the main body wall 12 and the lock member 51 is provided on the tray 13. In the example shown in FIG. 12(B), the connection terminals 41 and the lock member 51 are both provided on the main body wall 12.

In the present embodiment (see FIG. 4), configuration was made such that the battery pack 2 was set on the tray 13 in a vertical placement state with the handle side up, but configuration may be made such that the battery pack 2 is set on the tray 13 in a horizontal placement state with the handle side front.

In the example shown in FIG. 12(C), the battery pack 2 is set on the tray 13 in the horizontal placement state, the connection terminals 41 are provided on the tray 13, and the lock member 51 is provided on the main body wall 12. In the example shown in FIG. 12(D), the battery pack 2 is set on the tray 13 in the horizontal placement state, the connection terminals 41 are provided on the main body wall 12, and the lock member 51 is provided on the tray 13.

In the foregoing, description was made of embodiments to illustrate the technology disclosed in the present application. However, the technology of the present disclosure is not limited to them and may be applied to embodiments which may include change, replacement, addition, omission, etc. Also, new embodiments may be made by combining the components described with respect to the above embodiments.

### INDUSTRIAL APPLICABILITY

The battery exchange device and the battery exchange system according to the present disclosure can considerably reduce the burden on the user regarding the battery exchange, and are useful as a battery exchange device and a battery exchange system configured to charge multiple battery devices shared in a battery exchange service and to rent the charged battery devices to users.

### LIST OF REFERENCE NUMERALS

1 electric vehicle
2 battery pack (battery device)
3 battery exchanger (battery exchange device)
4 face authentication machine (authentication device)
5 management server (server device)
11 battery charging module (battery charger)
12 main body wall (support)
13 tray
15 display
19 processor
21 main body
22 handle
31 camera
32 display
33 privacy panel
41 connection terminal
42 power feeding terminal
43 communication terminal
45 display
47 tray storage
48 support shaft
49 terminal driver
51 lock member
52 lock driver
61 recess
62 guide surface

1. A battery exchange device configured to charge multiple battery devices shared in a battery exchange service and to rent the charged battery devices to users, the battery exchanger device comprising multiple battery chargers arranged side by side on a support and each configured to receive one of the multiple battery devices, wherein each battery charger comprises:
a tray for holding the battery device in a predetermined setting position;
a power feeding terminal for transmitting electric power for charging to the battery device; and
a lock member for prohibiting release of the battery device from the setting position,
wherein the support is wall-shaped, and
wherein the tray is provided to be capable of advancing and retreating between a use position in which the tray protrudes from a front surface of the support in a substantially horizontal direction such that the battery device can be placed on an upper surface and a storage position in which the tray is stored in the support.

2. The battery exchange device according to claim 1, wherein the tray is provided with a display that displays a state of charge of the battery device.

3. The battery exchange device according to claim 1, wherein the tray is provided to be pivotable between the storage position in which a tip side faces upward and the use position.

4. The battery exchange device according to claim 1, wherein the lock member is provided to be capable of advancing and retreating between a lock position in which the lock member restrains the battery device and an unlock position in which the lock member does not restrain the battery device.

5. The battery exchange device according to claim 1, wherein the power feeding terminal is provided to be capable of advancing and retreating between a connection position in which the power feeding terminal is connected to the battery device and a non-connection position in which the power feeding terminal is not connected to the battery device.

6. The battery exchange device according to claim 5, wherein the power feeding terminal is provided on the tray to be movable up and down, and when the battery device is in the setting position, the power feeding terminal protrudes from the tray and is connected to the battery device.

7. The battery exchange device according to claim 1, wherein the battery device is placed on the tray in a vertical placement state in which a handle is positioned on an upper side.

8. The battery exchange device according to claim 1, wherein the support has a recess for receiving a part of the battery device, and a guide surface for guiding the battery device to the setting position is formed on a peripheral part of the recess.

9. A battery exchange system, comprising:
multiple battery devices shared in a battery exchange service;
a battery exchange device configured to store and charge the battery devices and to rent the charged battery devices to users;
an authentication device that executes a process related to user authentication of a person who has visited for battery exchange; and
a server device that is connected to the battery exchange device and the authentication device via a network and manages user authentication at the authentication device and battery exchange at the battery exchange device,
wherein the battery exchange device comprises multiple battery chargers arranged side by side on the support and each configured to receive one of the multiple battery devices,
wherein each battery charger comprises:
a tray for holding the battery device in a predetermined setting position;
a connection terminal for transmission of electric power for charging and battery management information to and from the battery device; and
a lock member for prohibiting release of the battery device from the setting position,
wherein the support is wall-shaped,
wherein the tray protrudes from a front surface of the support in a substantially horizontal direction such that the battery device can be placed on an upper surface, and
wherein the server device acquires authentication information related to the person who has visited for battery exchange from the authentication device, determines whether to permit the battery exchange based on the authentication information, and when determining that the battery exchange may be permitted, controls a state of the tray, the connection terminal, and the lock member in the battery charger.

10. The battery exchange system according to claim 9, wherein the server device controls the state of the tray of each battery charger of the multiple battery chargers that is in a vacant state in which the battery device is not set.

11. The battery exchange system according to claim 9, wherein the server device controls the state of the connection terminal and the lock member of each battery charger of the multiple battery chargers that is in a state in which a charged, rentable battery device is set.
